(19) United States
(12) Patent Application Publication
(10) Pub. No.: US 2007/0219866 A1
(43) Pub. Date: Sep. 20, 2007

(54) Passive Shopper Identification Systems Utilized to Optimize Advertising

(76) Inventors: Robert Wolf, Sandy, UT (US); Robert Brazell, Salt Lake City, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/685,316

(22) Filed: Mar. 13, 2007

Related U.S. Application Data
(60) Provisional application No. 60/783,309, filed on Mar. 17, 2006.

(51) Int. Cl. G06Q 30/00

(52) U.S. Cl. 705/14

(57) ABSTRACT

The present invention relates to a method of optimizing advertising. More particularly, the present invention relates to methods for utilizing a mobile communications device to track consumer shopping patterns and purchases in association with a loyalty tracking device, which uniquely identifies each particular customer as they proceed through a shopping environment.

### RELATED APPLICATION

This application claims priority to U.S. Patent Application Ser. No. 60/783,309, filed Mar. 17, 2006 and entitled “Passive Shopper Identification System Utilized to Optimize Advertising.”

### BACKGROUND

1. Field of the Invention

The present invention relates to a method of optimizing advertising. More particularly, the present invention relates to methods for utilizing a mobile communications device to track consumer shopping patterns and purchases in association with a loyalty tracking device, which uniquely identifies each particular customer as they proceed through a shopping environment.

2. Background

Advertising is the process through which companies attempt to convince customers to purchase their products. Advertising takes many forms including radio advertisements, in-store audio advertisements, television advertisements, billboards, etc. The production and broadcasting of these advertisements has become more and more expensive. Companies wish to maximize the effect of their advertisements by determining the most effective message to promote. Numerous marketing textbooks and classes discuss this field.

One of the major obstacles in creating effective advertising is determining a customer's response to a particular advertisement. Traditionally companies have used focus groups and surveys in order to obtain customer response information about their products and/or advertisements. This customer response information can then be used to adjust or manipulate their advertisements. Unfortunately, these techniques of generating customer response information have been found to be inadequate and often inaccurate. Therefore, there is a need for a new method of generating customer response information that is both efficient and reliable.

Another problem with maximizing the effectiveness of advertising is the significant time delay between obtaining the customer response data, creating the advertisement, and broadcasting the advertisement. In many circumstances, the initial data indicating what will be effective in advertising a particular product may expire or become inaccurate. Therefore, there is also a need for a process that is able to efficiently generate an advertisement with respect to time sensitive customer response data.

Yet another problem with maximizing the effectiveness of advertising is the need to identify the most appropriate target audience. Some products are purchased by a wide variety of customers such as toilet paper and toothpaste while others are purchased by only a particular group. A significant loss in advertising effectiveness results if a wide-use product is only advertised to a select group of customers. Therefore, there is a need in the industry for a process of identifying a target group for a particular product, which can then be used to maximize the efficiency of a particular advertisement directed at selling the product. Further, there is a need to specifically tailor the content and durations of advertisements to reflect the shopping behaviors of each customer individually

### SUMMARY

The present invention relates to methods of tracking customers through a shopping environment and correlating the path traced by a particular individual with the items purchased. In some embodiments, the tracking may be accomplished by utilizing a combination of a mobile communications device and a loyalty tracking device.

One embodiment of the present invention relates to a method of acquiring data about the shopping habits of a particular individual by locating a position identifying marker on a mobile communications device carried by the individual. The data acquired by tracking an individual through a shopping environment may include the duration of time spent in any given shopping environment, and may include the path taken by the customer as the customer traverses the shopping environment.

In some embodiments, data related to the customer's movement through a shopping environment may be correlated with customer loyalty information. Some embodiments of the present invention comprise of a system for correlating the path taken, the duration spent at any given point, items purchased in a particular shopping experience by a given individual.

In some embodiments of the present invention, the mobile device carried by the individual will contain data which uniquely identifies the individual. Some embodiments of the present invention are capable of associating the shopping behaviors and purchasing habits with a particular individual.

In some embodiments, the data collected on a given individual may subsequently be utilized for multiple purposes. In a preferred embodiment of the present invention, the data collected relative to a particular shopper's behaviors and tendencies during shopping may be utilized to modify and individualize advertisements perceived by the shopper as they traverse the shopping environment. Accordingly, in some embodiments as the individual enters the shopping environment and proceeds to a position within a store, advertisements particularly tailored to the customer shopping preferences are visually or audibly communicated to the customer.

In addition to tailoring the content of an advertisement to reflect a data collected on a customer's shopping behaviors, the duration of time a customer normally resides in an area may be utilized to tailor the length of a message or advertisement communicated to the customer.

Some embodiments utilize various forms of data collection regarding consumer behavior in a shopping environment and utilize said data to modify the advertising perceived by each consumer. Accordingly, some embodiments relate to providing customized and individualized advertisements based on stored data. Some embodiments of the present invention contemplate using various mobile communications devices for tracking customers through store and various means for identifying consumers once they have entered the shopping environment and various means for tracking the items purchased on each shopping excursion.

These and other features and advantages of the present invention will become more fully apparent in the description as follows and the appended claims. The features and advantages may be realized and obtained by means of the instruments in combination particularly pointed out in the appended claims. Furthermore, the features and advantages of the invention may be learned by practice of the invention or will be obvious from the description as set forth herein.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a representative system that provides a suitable operating environment for use of the present invention;

FIG. 2 is a flow chart illustrating one embodiment of a method for optimizing an advertisement in response to customer data;

FIG. 3 is a flow chart illustrating one embodiment of a method for acquiring customer response data including optimum advertising variable settings for a plurality of advertising groups;

FIG. 4 is a flow chart illustrating one embodiment of a method for broadcasting a plurality of test advertisements with unique sets of advertisement variable settings; and

FIG. 5 is a flow chart illustrating one embodiment of a method for automatically broadcasting an efficient advertisement with respect to present customers.

### DETAILED DESCRIPTION OF THE PREFERRED EMBODIMENTS

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The present invention relates to a method of optimizing advertising more particularly, the present invention relates to a method for utilizing a mobile communications device to track consumer shopping patters and purchases in association with a loyalty tracking device, which uniquely identifies a particular customer and their shopping behaviors as they proceed through a shopping environment.

As used in this specification, the following terms are defined accordingly:

“Mobile communications device” is defined herein as a mobile, bi-directional communication device which includes all forms of mobile communication devices including but not limited to mobile phones, bluetooth technology, global-positioning system (GPS), and any combination thereof.

“Advertisement” includes all forms of advertising; including but not limited to audio, video, still visual, touch, taste, smell, and any combination thereof.

“Optimized advertisement” is an advertisement that is specifically optimized for a specific individual and/or specific advertising target group.

“Advertising variable settings” include the settings of various variables that affect how an advertisement is perceived. These variables include but are not limited to frequency, duration, play time, volume, gender of speaker(s)/actor(s), sound/video icons, smell icons, taste icons, background music/scenery, sound effects, special effects, presence/absence of pricing information, variations in pricing, variations in offer, value added content, seasonal related message, category promotions, variations on the product message, and promotional offers.

“Optimized advertising variable settings” is a set of advertising variable settings that are optimized for a particular individual and/or advertising target group.

“Advertising group” is a group of people who share at least one characteristic or trait.

“Advertising target group” is a group of people who share at least one characteristic and who are targeted for a particular advertisement. For example, males over 50 years old may be an advertising target group for a luxury automobile.

“Advertisement components” are various components of an advertisement that can be used independently or compiled with other components to create a complete advertisement. For example, various prices may be recorded for an audio advertisement and then compiled with other information into complete advertisements as the price of a particular item is lowered.

“Optimization algorithm” is a procedure that is used to obtain the most efficient variable setting for a unique input.

The following disclosure of the present invention is grouped into two subheadings, namely “Exemplary Operating Environment” and “Passive Customer Tracking.” The utilization of the subheadings is for convenience of the reader only and is not to be construed as limiting in any sense.

### Exemplary Operating Environment

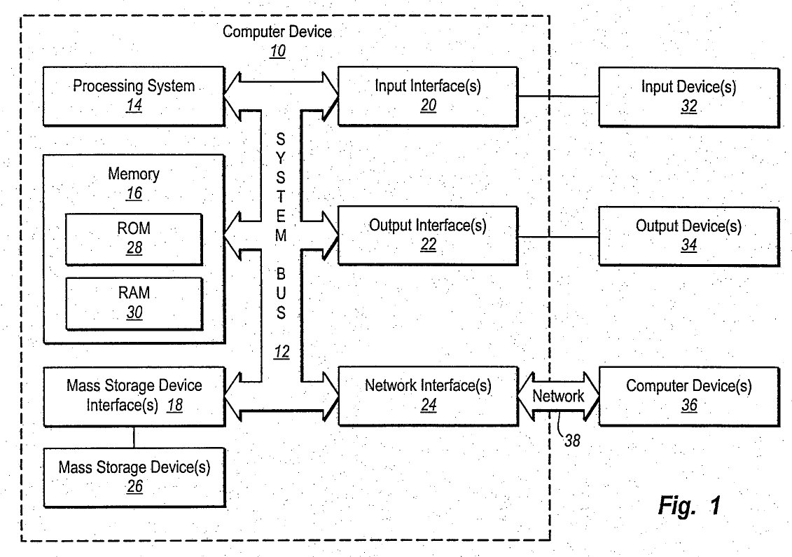

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration. Alternatively, the invention may also be practiced in whole or in part manually following the same procedures.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

### Passive Customer Tracking

The present invention relates to methods of tracking customers through a shopping environment and correlating the path traced by a particular individual with the items purchased. In some embodiments, the tracking may be accomplished by utilizing a combination of a mobile communications device and a loyalty tracking device.

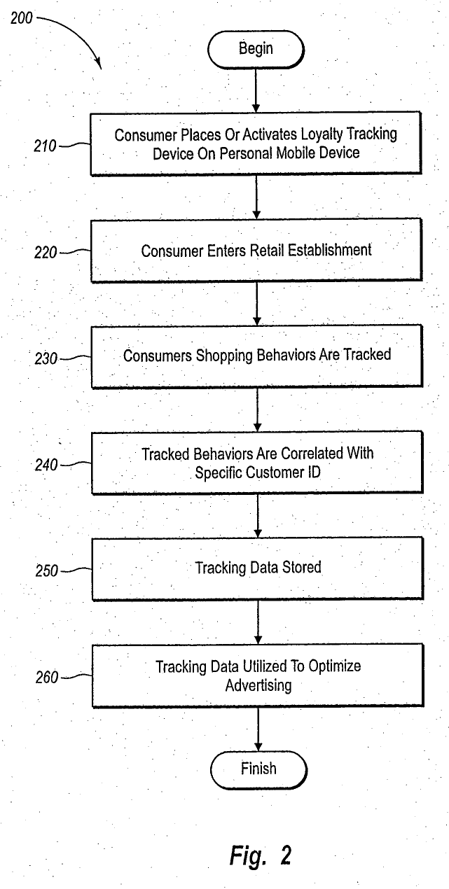

Reference is next made to FIG. 2, which is a flow chart illustrating one embodiment of a method for optimizing advertising in response to customer data designated generally as 200. Although acts are shown and described in a sequential order, the steps may be performed in any order in relation to one another. The method 200 begins by a consumer placing or activating a loyalty tracking device on a personal mobile communications device. In some embodiments, the loyalty tracking device specifically identifies the individual by a serial number or by some other identification means. In some embodiments, the mobile communications device used by a consumer may be a mobile phone, a PDA, or any other mobile, bi-directional communication device.

In some embodiments, the tracking device associated with an individual may not contain the customer's loyalty tracking information, or may not contain information previously disposed on the system by the individual. In a non-limiting example, a customer may enter a grocery marketplace or other commercial marketplace, once within range of tracking devices, some embodiments of this system may track the individual through a retail environment, uniquely identifying the individual by a serial number or other means of identification uncorrelated with or not in connection with personal data supplied by the consumer. Accordingly, in some embodiments consumer X may be tracked through a given store or through multiple stores and, their shopping behaviors and purchasing habits may be acquired.

In some embodiments, a consumer may provide data which may be used as a basis for correlating the loyalty data tracking. In preferred embodiments a customer may log onto a web site and provide personal information comprising name, address and certain shopping preferences. That personal data, in some embodiments, is correlated with a particular shopper and when that shopper enters the shopping environment, the tracking information acquired by tracking the consumer's mobile device through the shopping environment is correlated with the shopper's personal data. In some embodiments, the personal data and real time knowledge of the customer's position in a retain environment can allow for customer specific and geographic specific advertisements, coupons or shopping lists to be provided to the customer. In some embodiments, a consumer may, prior to entering a shopping environment, type a shopping list which may be included in a customer's personal data. When the particular customer enters a retail environment that contains items on their list, the customer may receive prompts on their mobile device directing them to purchase an item on their list. Additionally, in other embodiments, the data provided by a customer may be correlated with the particular geographical position of a consumer in a retail environment and coupons germane to that customer's preferences and to the geographic position of that customer in a retail environment may be supplied to the customer on their mobile device. The device may also be utilized in the same way to provide advertisements to customers in a personal and geographically appropriate way. In a non-limiting example, a customer who has input personal information and who has a prior history of purchasing a particular product may receive a coupon or advertisement prompting them to purchase that product or a related product when that particular customer is occupying a particular space in a retail environment. In some embodiments, the particular space occupied by the customer may be the aisle in which the product resides or may be a position historically occupied by the consumer prior to moving to a place where the product resides. Accordingly, in some embodiments there is a substantial overlap between the loyalty data and use of the mobile device.

In some embodiments of the present invention, the mobile communications device carried by an individual will contain data that uniquely identifies the individual. In a non-limiting example, a mobile phone carried by a customer may have a customer identification number associated with it, so that any tracking information received from the mobile communications device would be associated with a serial number particularly associated with a specific individual customer. In this way, some embodiments are capable of associating the shopping behaviors and purchasing habits with a particular individual.

In some embodiments, at any given time a consumer may enter a retail establishment 220. If such a customer has placed or activated a loyalty tracking device on a personal mobile communications device that consumer's shopping behaviors are then tracked 230. Even if no loyalty device has been activated, a consumer may be as previously discussed tracked through a retain environment wherein the tracking information is stored accumulated and processed independent of personal information that may have otherwise been provided by the shopper. In some embodiments of the present invention, the method of acquiring data about the shopping habits of a particular individual is accomplished by locating a position identifying marker on a mobile communications device carried by an individual. In a non-limiting example an individual may carry a mobile phone with a global positioning system on-board, or some other tracking means including RFID tags. Additionally, a consumer may use a PDA, or other device with bluetooth technology. The data acquired by tracking an individual through a shopping environment may include the duration of time spent in any given shopping environment, and may include the path taken by a customer as they traverse the shopping environment

In some embodiments, the data created by tracking shopper's consumer behaviors are correlated with a specific customer identification number 240, previously supplied personal information and/or previously acquired loyalty tracking data. Even if data was not previously supplied by or previously acquired a particular customer, a customer identification number may be assigned to any customer tracked through the retail environment. In some embodiments, the customer data related to the customer's movements through a shopping environment, duration of time spent in a given shopping environment and itemized list of items purchased may be correlated with customer loyalty information. Accordingly, some embodiments of the present invention provides a system for correlating the path taken, the duration taken at any point, items purchased in a particular shopping experience by a given individual, and such data may be correlated with a specific customer identification number, or other means for uniquely identifying a particular shopper.

In some embodiments, the tracking data which has been correlated with a specific customer ID may be stored for subsequent use 250.

In some embodiments, the data collected and store may subsequently be utilized for multiple purposes 260. In preferred embodiments of the present invention, the data collected may be utilized to modify and individualize an advertisement perceived by shoppers as they traverse shopping environments 260. In a non-limiting example, a customer for whom data has been acquired enters a shopping environment 220. The customer is recognized by a serial number associated with a mobile communications device owned by a customer (e.g. a cellular phone with GPS). Once identified, advertisements specifically tailored to the individual based on past shopping data, may be routed to and played in an environment typically traced by said individual or on the customer's mobile device. Accordingly, as the individual enters the shopping environment, and proceeds to a position within the store, advertisements particularly tailored to a customers shopping preference are visually and auditorily communicated to the consumer. In a non-limiting example, a customer who normally purchases Yogurt enters the dairy department to purchase milk, wherein an audio broadcast alerts the customer to a discounted price on yogurt in the store that day. Accordingly, based on the customer's prior shopping preferences for yogurt, the advertisement broadcast in the dairy is tailored for the individual's shopping preference.

In some embodiment, in addition to tailored content, other advertising variable settings may be modified to particularly suit the consumer's behaviors. Advertisement variable settings include the settings of various variables that effect how an advertisement is perceived. These variables include, but are not limited to frequency, duration, play time, volume, gender of speaker/actor, sound, video icons, smell, taste icons, background music/scenery, sound effects, special effects, presence/absence of pricing information, variation in pricing, variation in offer, value, added content, seasonally related messages, category promotions, variations on the product message, and promotional offers. In some embodiments of the present invention each of the named advertising variable settings may be optimized relative to the data set established for a particular customer.

In a non-limiting example, a customer who spends a very short period of time in each area of the store would be presented with a short advertisement, knowing that long advertisements would not be completely consumed by such a consumer, whereas, a consumer who tends to linger for a substantial period of time in an area would be presented with advertisements containing substantially more content. In like fashion, any of the advertising variable settings may be modified to suit the shopping behaviors of an individual. In a non-limiting example, if the volume or gender of a speaker/actors voice has adversely affected purchasing decision by a particular consumer historically, such advertising variable settings may be modified to optimally increase the potential opportunity for purchase.

Accordingly, some embodiments utilize variable forms of data collection regarding consumer behavior in a shopping environment and utilize said data to modify advertising perceived by a customer. Accordingly, the present invention relates that providing customized and individualized advertisements based on store data customer loyalty tracking, previously supplied personal information and/or other data.

This technology provides numerous advantages over the prior art. In a non-limiting example, an audience may be targeted in advertisements modified in real time. Audience targeting allows for advertisements to be tailored or to specifically target a customer. Real time measurements include identifying a customer's response to a particular advertisement. Accordingly, in some embodiments of the present invention efficacy of the targeted advertisement may be measured by determining a customer's response to targeted advertisements of purchasing the advertised material.

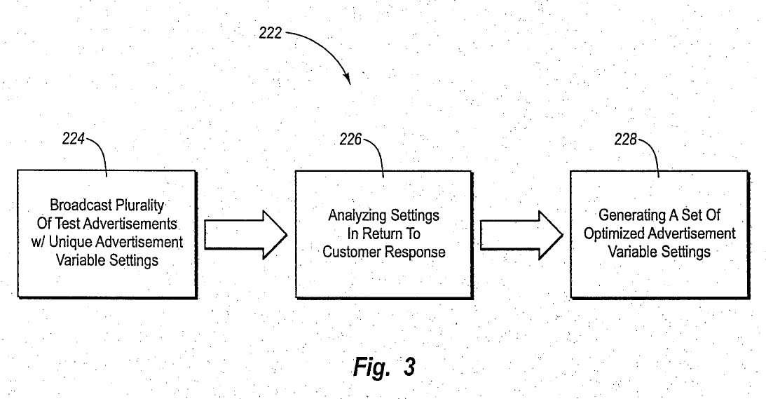

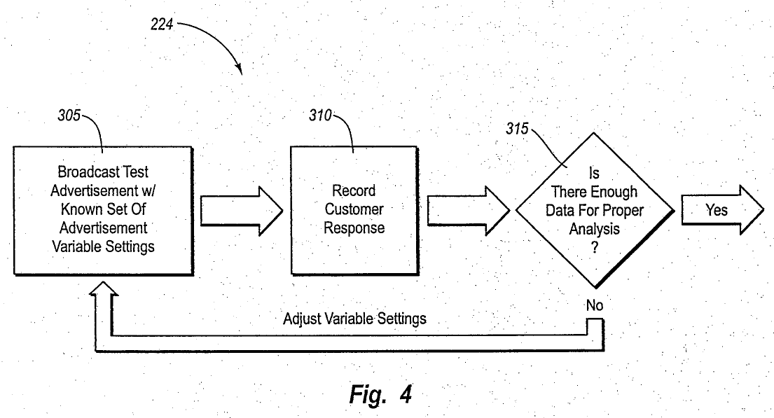

Reference is next made to FIG. 3, which is a flow chart illustrating one embodiment of a method for acquiring customer response data including optimal advertisement variable settings. The method is generally designated as 222 corresponding generally to an embodiment depicted in FIG. 2. Accordingly, in some embodiments a consumer enters a retail environments establishment 220 and is subsequently exposed to a broadcast of a plurality of advertisements with unique variable settings 224. The method 222 may be performed independently or is a part of a method described with respect to FIG. 2. Initially, in some embodiments, the plurality of advertisements are broadcast with unique advertising variable settings 224. These advertisements are actual advertisements that broadcast with known advertising variable settings. Each of a plurality of broadcast advertisements has unique advertising variable settings. One embodiment of broadcasting a plurality of test advertisements is described in more detail with reference to FIG. 4. The act of broadcasting a plurality of test advertisements includes recording customer response data that may be correlated with each of the test advertisements.

Once the plurality of test advertisements are broadcasted, the advertising variable settings of each of the test advertisements are analyzed in relation to the corresponding customer response data, act 226. It is desirable to attempt to correlate which advertising variable settings affect which customer groups by identifying which test advertisements cause customers to respond in positive ways. Naturally, some customer groups will overlap with one another and certain advertising variable settings may affect customer groups in different ways. This analysis can be performed manually, automatically, or some combination thereof. Various automatic computer algorithms could be used which are known to those skilled in the art.

Once the analysis is complete, a set of optimized advertisement variables is created for a particular advertising target group or for a particular individual, act 228. The set of optimized advertising variable settings may or may not be a complete set of advertising variable settings. For example, a specific customer may prefer a female voice, at high volume, repeated frequently, a rose smell, and with lots of sound effects. This set of optimized advertising variable settings is not a complete set of advertising variable settings and will allow the remaining variables to be set at random or set for another purpose.

Reference is next made to FIG. 4, which is a flow chart illustrating one embodiment of a method for broadcasting a plurality of test advertisements with unique sets of advertisement variable settings. The method is designated generally at 224 corresponding to the similar act in FIG. 3. This method may be performed independently or as part of the method described with respect to FIG. 3. Initially, a single test advertisement is broadcast with a known set of advertisement variable settings, act 305. As discussed above, the term “broadcast” is used broadly to describe any manner in which an advertisement may be exposed to the public. Numerous different advertisement variables may or may not be present in the broadcast test advertisement. For example, a video advertisement may also include a smell that is simultaneously dispensed from a plurality of sprayers. Likewise, an audio advertisement may include various sound effects. Likewise, a poster may include a display with particular touch characteristics. Customer's corresponding responses are then recorded, act 310.

A query is then performed to determine whether enough customer response data has been accumulated for proper analysis, act 315. If there is sufficient customer response data, the method will proceed to whatever next act or method is provided. If there is not sufficient customer response data for analysis, the advertisement variables will be adjusted and the act of broadcasting a test advertisement will be repeated, as shown. It should also be noted that any broadcast of an advertisement may be considered the broadcast of a test advertisement for the purpose of gathering additional customer response data. Therefore, this method 212 may be implemented continually through the process of advertising.

This act may be performed manually or automatically depending on the application. In a non-limiting example, as a customer enters a specified area and is identified by the loyalty tracking device on a customer's mobile tracking device and a customized advertisement with optimized advertised variable settings may be played to positively influence the consumer. In another non-limiting example a single customer group in one particular location recognized by the passive tracking of the present invention may be exposed to optimized advertising, which is particularly adapted to positively affect the group of consumers.

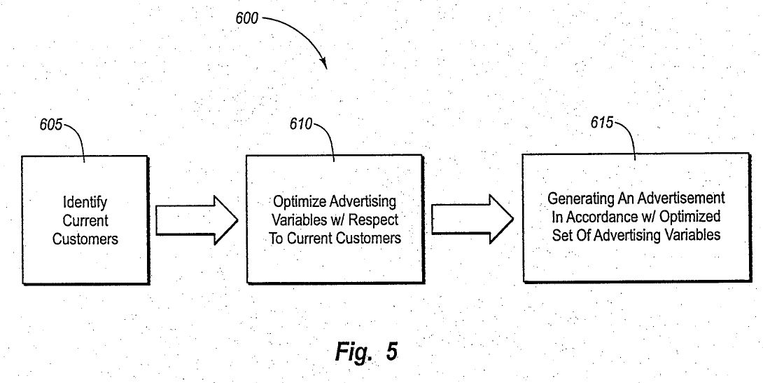

Reference is next made to FIG. 5, which is a flow chart illustrating one embodiment of a method for automatically broadcasting an efficient advertisement with respect to present customers. The method is designated generally at 600 and may be performed independently or as part of another method. Initially, a current set of customers is identified, act 605. The identity and characteristics of current customers is obtained through one or more techniques and/or technologies. For example, loyalty card scanning, video face recognition, manual input, mobile bidirectional communication device etc. Numerous technologies are becoming available that allow retailers to obtain customer information and customer response data. These technologies are known to those skilled in the art and the use of any such technology is consistent with the teachings of the present invention.

Once information is obtained about current customers, a set of optimized advertising variable settings can be dynamically determined that will maximize the effect of an advertisement, act 610. The optimized advertising variable settings may be the optimal variable settings for the most prevalent customer group in the store or they may be a custom set of advertising variable settings that is a statistically generated to maximize the affects of an advertisement. Various other techniques may also be used to determine the optimized advertisement variable settings.

After the optimized advertising variable settings are established, an advertisement is generated in accordance with the optimized advertising variable settings, act 615. The advertisement is dynamically generated in order to capitalize on the narrow time frame in which the advertising variable settings are optimized. The advertisement is compiled using advertisement components that are previously created in order to allow for flexibility in various advertising variable settings.

Thus, as discussed herein, the embodiments of the present invention embrace systems and methods for optimizing advertising. More particularly, the present invention relates to a method of acquiring advertising data and a method of optimizing advertising variable settings in response to acquired data. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed:

1. A method of optimizing advertising comprising:
activating a loyalty tracking device on a personal mobile communications device;
allowing a consumer to enter a retail establishment;
tracking the consumer's presence and shopping behaviors utilizing the loyalty tracking device in combination with a mobile communications device;
correlating the tracking behaviors with a specific customer identification number;
storing said tracking data; and
utilizing the tracking data to optimize advertisements.

2. The method of claim 1, wherein the advertisement is selected from a list consisting of audio, video and smell.

3. The method of claim 1, wherein the mobile communications device is selected from a list consisting of a mobile phone, a PDA, and RFID tag, and an electronic device with bluetooth technology.

4. The method of claim 1, wherein the advertising components include audio advertisement components with various audio advertisement content that can be spliced together to adjust the advertisement variable settings of the advertisement.

5. The method of claim 1, wherein the advertising components include audio components with different speakers.

6. The method of claim 1, wherein said compiling of an advertisement using the advertisement components that correspond to a set of optimized advertising variable settings for an advertising target group, further includes:
broadcasting a plurality of test advertisements with unique sets of advertisement variable settings;
analyzing broadcasted advertisement variable settings in relation to customer response information; and
generating a set of optimized advertisement variable settings for a plurality of advertising groups.

7. The method of claim 1, wherein the advertising variable settings include at least one of:
(i) frequency of the advertisement;
(ii) duration of the advertisement;
(iii) play time of the advertisement; and
(iv) volume of the advertisement.

8. The method of claim 1, wherein the advertising variable settings include at least one of:
(i) inclusion of sound icons;
(ii) background music played in the advertisement; and
(iii) sound effects played in the advertisement.

9. The method of claim 1, wherein the advertising variable settings include at least one of:
(i) presence of pricing information in the advertisement;
(ii) variations in pricing in the advertisement; and
(iii) variations in offer made in the advertisement.

10. The method of claim 1, wherein the advertising variable settings include at least one of:
(i) seasonal related messaging included in the advertisement;
(ii) category promotions included in the advertisement; and
(iii) promotional offers included in the advertisement.

11. The method of claim 1, wherein the advertising variable settings include at least one of:
(i) variations on a product message included in the advertisement; and
(ii) value added content included in the advertisement.

12. The method of claim 1, wherein the advertising variable settings include a gender of the speaker in the advertisement.

13. The method of claim 1, wherein the advertising variable settings include smell icons for distributing a smell as part of the advertisement.

14. A method for generating an advertisement with optimized advertising variable settings for an advertising target group, the method comprising:
a consumer entering a retail establishment;
tracking the consumer's shopping behaviors utilizing the loyalty tracking device in combination with a mobile communications device;
correlating the tracking behaviors with a specific customer identification number;
storing said tracking data; and
utilizing the tracking data to optimize advertisement.

15. The method of claim 14, wherein the advertising components include video advertisement components with various video advertisement content that can be spliced together to adjust the advertisement variable settings of the advertisement.

16. The method of claim 14, wherein the optimized advertising variable settings include at least one of:
(i) frequency of the advertisement;
(ii) duration of the advertisement;
(iii) play time of the advertisement; and
(iv) volume of the advertisement.
(v) visual display characteristics of the advertisement, which may include, but are not limited to, brightness, color selection, color depth, and displayed-text properties.

17. The method of claim 14, wherein the optimized advertising variable settings include at least one of:
(i) inclusion of visual and sound icons;
(ii) background music and images played in the advertisement; and
(iii) visual and sound effects played in the advertisement.

18. The method of claim 14, wherein the optimized advertising variable settings include at least one of:
(i) presence of pricing information in the advertisement;
(ii) variations in pricing in the advertisement; and
(iii) variations in an offer made in the advertisement.

19. The method of claim 14, wherein the optimized advertising variable settings include at least one of:
(i) seasonal related messaging included in the advertisement;
(ii) category promotions included in the advertisement; and
(iii) promotional offers included in the advertisement.

20. The method of claim 14, wherein the optimized advertising variable settings include at least one of:
(i) variations on a product message included in the advertisement; and
(ii) value-added content included in the advertisement.

21. The method of claim 14, wherein the optimized advertising variable settings include a gender of the speaker or actor in the advertisement.

22. The method of claim 14, further comprising broadcasting the advertisement, wherein said broadcasting the advertisement includes distributing a smell.

23. The method of claim 14, wherein the optimized advertising variable settings include smell icons for distributing a smell as part of the advertisement.

24. computer program product for implementing within a computer system a method for generating an advertisement with optimized advertising variable settings for an advertising target group, the computer program product comprising:
a consumer entering a retail establishment;
tracking the consumer's shopping behaviors utilizing the loyalty tracking device in combination with a mobile communications device;
correlating the tracking behaviors with a specific customer identification number;
storing said tracking data; and
utilizing the tracking data to optimize advertisement.
